(19) United States
(12) Patent Application Publication
(10) Pub. No.: US 2019/0080317 A1
(43) Pub. Date: Mar. 14, 2019

(54) SYSTEM AND METHOD FOR LOCKING DIGITAL CONTENT AND GRANTING ACCESS TO THE LOCKED DIGITAL CONTENT

(71) Applicant: Orson Tormey, Bangkok (TH)

(72) Inventor: Orson Tormey, Bangkok (TH)

(73) Assignee: Orson Tormey, Highland Park (AU)

(21) Appl. No.: 16/125,705

(22) Filed: Sep. 9, 2018

Related U.S. Application Data
(60) Provisional application No. 62/556,348, filed on Sep. 9, 2017.

(51) Int. Cl. G06Q 20/34; H04L 12/58; H04L 29/08

(52) U.S. Cl. CPC G06Q 20/34; G06F 17/2288; H04L 67/02; H04L 51/12

(57) ABSTRACT

Disclosed is a system and method for locking digital content and granting access to the locked digital content. The method provides a locked version of the digital content. Then the method enables a user to feed an e-mail address to access a complete version of the digital content through an email address module. The method further enables a user to feed information pertaining to initiate a payment to access the complete version of the digital content through a payment module. The complete version of the digital content is displayed over a computing device of the user after receiving at least one of the e-mail address and the payment from the user. The method provides a hyperlink to an individual piece of a limited or locked digital content that can be turned into a complete version of the digital content, with an e-mail address or a predefined payment amount.

### TECHNICAL FIELD

The present invention relates to a system and method for providing digital content. More particularly, the presently disclosed embodiments are related to a system and method for locking digital content and granting access to the locked digital content on receiving either a predefined payment amount or an e-mail address of a user.

### BACKGROUND

Background description includes information that may be useful in understanding the present invention. It is not an admission that any of the information provided herein is prior art or relevant to the presently claimed invention, or that any publication specifically or implicitly referenced is prior art.

Rapid improvements in the digital world have changed the distribution and monetization methods of the digital content. The digital content in the form of learning modules, books, journals, magazines, informative slides or blogs is one of the most valuable assets for the of the digital content providers. The popularity of the Internet and the use of computing devices have further increased the demand for digital content. Digital content providers face various challenges to access control, distribute and monetize the digital content while keeping abreast with the new business models to generate profit.

There is a need for a system and method to provide an integrated platform to the digital content providers to stay up to speed with the advancing digital content market by utilizing social media marketing strategies to increase the revenue, customer and subscriber base. Further, there is also a need for a system and method for locking the digital content and providing access to the locked digital content on receiving payment or e-mail address of the user.

Thus, in view of the above, there is a long-felt need in the industry to address the aforementioned deficiencies and inadequacies.

Further limitations and disadvantages of conventional and traditional approaches will become apparent to one of skill in the art through comparison of described systems with some aspects of the present disclosure, as set forth in the remainder of the present application and with reference to the drawings.

### SUMMARY

The present invention mainly solves the technical problems existing in the prior art. In response to these problems, the present invention provides a system and method for locking digital content and granting access to the locked digital content.

An aspect of the present disclosure relates to a system to lock digital content and grant access to the locked digital content. The system includes a processor and a memory. The memory stores machine-readable instructions that when executed by the processor cause the processor to provide a locked version of the digital content through a locked content module. The process is then configured to enable a user to feed an e-mail address to access a complete version of the digital content through an email address module.

Further, the processor is configured to enable a user to feed information pertaining to initiate a payment to access the complete version of the digital content through a payment module. The information comprises a name of the user, e-mail address of the user, and payment card details of the user. The processor is then configured to grant access to the complete version of the digital content through a digital content module. The complete version of the digital content is displayed over a computing device of the user after receiving at least one of the e-mail address and the payment from the user.

Then the processor is configured to enable a digital content provider to create at least two versions of the digital content in a graphics program through a sign-up lock content module adaptable to receive the e-mail address from the user. The first version provides the digital content in a lock mode, and the second version provides the digital content in an unlocked mode. The processor is further configured to enable the digital content provider to integrate an unlock button to the first version of the digital content through a sign-up lock editor module. The unlock button linked to a sign-up form and redirects to display the complete version of the digital content on receiving the e-mail address of the user in the sign-up form.

The processor is further configured to provide a user with a promotional link on a social media platform through a sign-up lock user experience module. Then the processor is configured to enable the digital content provider to create at least two versions of the digital content in a graphics program through a payment lock content module adaptable to receive the payment from the user. The first version provides the digital content in a lock mode, and the second version provides the digital content in an unlocked mode.

The processor is configured to enable the digital content provider to integrate a link to a hotspot in the first version of the digital content through a payment lock editor module. The payment lock editor module enables the digital content provider to select a pay lock option. Further, the digital content provider integrates a product ID from a payment gateway. The product ID relates to a predefined price of the corresponding digital content. Then the processor is configured to provide a user with a promotional link on a social media platform through a payment lock user experience module.

In an aspect, the sign-up lock editor module enables the digital content provider to select a sign-up lock option. The digital content provider further selects a desired location to save the received e-mail addresses of the users.

In an aspect, the locked version of the digital content comprises a plurality of tutorials, a plurality of multimedia files (audios/videos), and a plurality of templates.

In an aspect, the sign-up lock editor module enables the digital content provider to configure a signup image, a signup description, and a submit label.

In an aspect, the sign-up lock editor module enables the digital content provider to integrate a first web address URL to enable the user to access the complete digital content by submitting the e-mail address.

In an aspect, the payment lock editor module enables the digital content provider to integrate a second web address URL which redirects the user to access the complete digital content on receiving the payment.

An aspect of the present disclosure relates to a computer-implemented method for locking digital content and granting access to the locked digital content. The method comprises a step of providing a locked version of the digital content through a locked content module. Then the method includes a step of enabling a user to feed an e-mail address to access a complete version of the digital content through an email address module. The method further includes a step of enabling a user to feed information pertaining to initiate a payment to access the complete version of the digital content through a payment module. The information comprises a name of the user, e-mail address of the user, and payment card details of the user. The method includes a step of granting access to the complete version of the digital content through a digital content module.

The complete version of the digital content is displayed over a computing device of the user after receiving at least one of the e-mail address and the payment from the user. Further, the method includes the step of enabling a digital content provider to create at least two versions of the digital content in a graphics program through a sign-up lock content module adaptable to receive the e-mail address from the user. The first version provides the digital content in a lock mode, and the second version provides the digital content in an unlocked mode. The method then includes the step of enabling the digital content provider to integrate an unlock button to the first version of the digital content through a sign-up lock editor module. The unlock button linked to a sign-up form and redirects to display the complete version of the digital content on receiving the e-mail address of the user in the sign-up form. Furthermore, the method includes the step of providing a user with a promotional link on a social media platform through a sign-up lock user experience module.

The method then includes the step of enabling the digital content provider to create at least two versions of the digital content in a graphics program through a payment lock content module adaptable to receive the payment from the user. The first version provides the digital content in a lock mode, and the second version provides the digital content in an unlocked mode. Then the method includes the step of enabling the digital content provider to integrate a link to a hotspot in the first version of the digital content through a payment lock editor module. The payment lock editor module enables the digital content provider to select a pay lock option. Further, the digital content provider integrates a product ID from a payment gateway. The product ID relates to a predefined price of the corresponding digital content. Then the method includes a step of providing a user with a promotional link on a social media platform through a payment lock user experience module.

Accordingly, one advantage of the present invention is that it provides a hyperlink to an individual piece of a limited or locked digital content that can be turned into a complete version of the digital content, with an e-mail address or a predefined payment amount.

Accordingly, one advantage of the present invention is that it provides an integrated platform to the digital content providers to stay up to speed with the advancing digital content market by utilizing social media marketing strategies to increase the revenue, customer and subscriber base.

Other features of embodiments of the present disclosure will be apparent from accompanying drawings and from the detailed description that follows.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a network implementation of the present system and method for locking digital content and granting access to the locked digital content, in accordance with at least one embodiment;

FIG. 2 illustrates a block diagram of the present system for locking digital content and granting access to the locked digital content, in accordance with at least one embodiment;

FIG. 3 illustrates a flowchart of the method for locking digital content and granting access to the locked digital content, in accordance with at least one embodiment;

FIG. 4 illustrates a first exemplary view of the locked content module, in accordance with at least one embodiment;

FIG. 5 illustrates an exemplary view of an e-mail address module, in accordance with at least one embodiment;

FIG. 6 illustrates first exemplary view of the digital content module, in accordance with at least one embodiment;

FIGS. 7a-7b illustrate an exemplary view of the sign-up lock content module, in accordance with at least one embodiment;

FIGS. 8a-8b illustrate an exemplary view of the sign-up lock editor module, in accordance with at least one embodiment;

FIG. 9 illustrates an exemplary view of the sign-up lock user experience module, in accordance with at least one embodiment;

FIG. 10 illustrates a second exemplary view of the locked content module, in accordance with at least one embodiment;

FIG. 11 illustrates an exemplary view of a payment module, in accordance with at least one embodiment;

FIG. 12 illustrates a second exemplary view of the digital content module, in accordance with at least one embodiment;

FIGS. 13a-13b illustrate an exemplary view of the payment lock content module, in accordance with at least one embodiment;

FIGS. 14a-14b illustrate an exemplary view of the payment lock editor module, in accordance with at least one embodiment; and

FIG. 15 illustrates an exemplary view of the payment lock user experience module, in accordance with at least one embodiment.

### DETAILED DESCRIPTION

Systems and methods are disclosed for locking digital content and granting access to the locked digital content. Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

If the specification states a component or feature “may”, “can”, “could”, or “might” be included or have a characteristic, that particular component or feature is not required to be included or have the characteristic.

Although the present disclosure has been described with the purpose of locking digital content and granting access to the locked digital content, it should be appreciated that the same has been done merely to illustrate the invention in an exemplary manner and any other purpose or function for which explained structures or configurations can be used, is covered within the scope of the present disclosure.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium may include a non-transitory medium in which data can be stored, and that does not include carrier waves and/or transitory electronic signals propagating wirelessly or over wired connections. Examples of a non-transitory medium may include but are not limited to, a magnetic disk or tape, optical storage media such as compact disk (CD) or digital versatile disk (DVD), flash memory, memory or memory devices.

A computer program product may include code and machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer program product) may be stored in a machine-readable medium. A processor(s) may perform the necessary tasks.

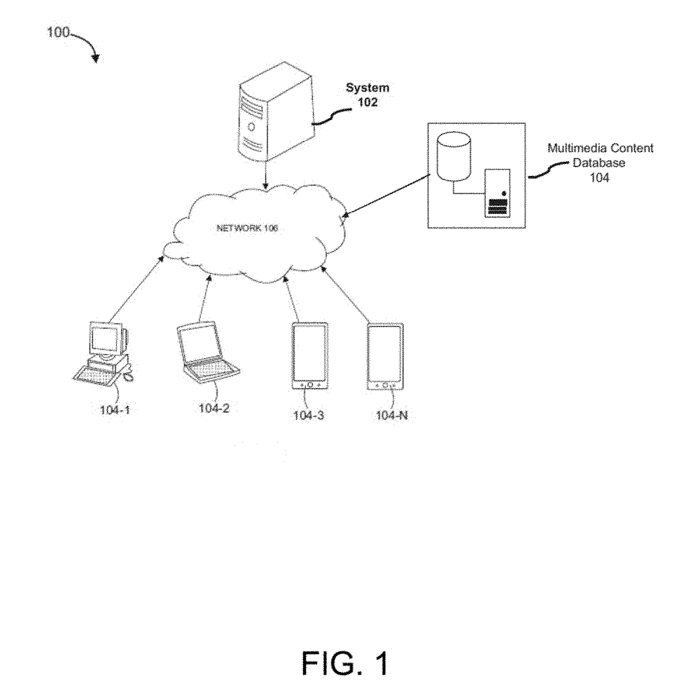

FIG. 1 illustrates a network implementation 100 of the present system and method for locking digital content and granting access to the locked digital content, in accordance with at least one embodiment. Although the present invention is explained by considering that the present system 102 is implemented on a server, it may be understood that the present system 102 may also be implemented in a variety of computing systems, such as a laptop computer, a desktop computer, a notebook, a workstation, a mainframe computer, a server, a network server, and the like. It will be understood that the present system 102 may be accessed by multiple users through one or more computing devices 104, collectively referred to as computing device 104 hereinafter, or applications residing on the computer devices 104. Examples of the computing devices 104 may include but are not limited to, a portable computer, a personal digital assistant, a handheld device, and a workstation. The computing devices 104 are communicatively coupled to the present system 102 through a network 106 and utilizes the various operating system to perform the functions of the present system 102 such Android, IOS, Windows, etc.

In one implementation, the network 106 may be a wireless network, a wired network or a combination thereof. The network 106 can be implemented as one of the different types of networks, such as an intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

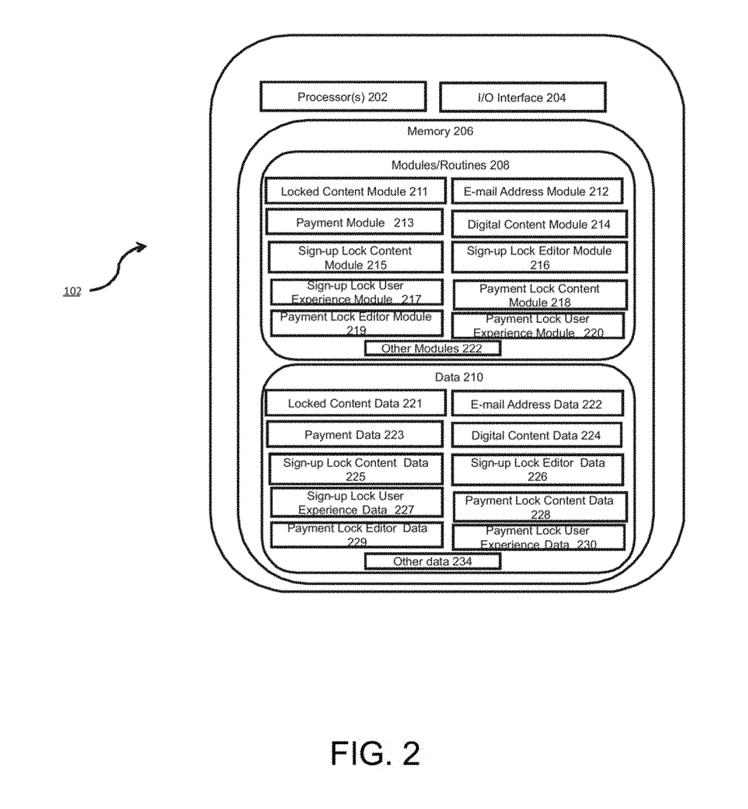

FIG. 2 illustrates a block diagram of the present system 102 for locking digital content and granting access to the locked digital content, in accordance with at least one embodiment. Referring now to FIG. 2, the system 102 is illustrated in accordance with an embodiment of the present subject matter. In one embodiment, the system 102 may include at least one processor 202, an input/output (I/O) interface 204, and a memory 206. The processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the computing devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a locked content module 211, an e-mail address module 212, a payment module 213, a digital content module 214, a sign-up lock content module 215, a sign-up lock editor module 216, a sign-up lock user experience module 217, a payment lock content module 218, a payment lock editor module 219, a payment lock user experience module 220, and other modules 222. The other modules 222 may include programs or coded instructions that supplement applications and functions of the system 102.

The data 210, amongst other things, serves as a repository for storing data processed, received, and generated by one or more of the modules 208. The data 210 may also include a locked content data 221, an e-mail address data 222, a payment data 223, a digital content data 224, a sign-up lock content data 225, a sign-up lock editor data 226, a sign-up lock user experience data 227, a payment lock content data 228, a payment lock editor data 229, a payment lock user experience data 230, and other data 234. The other data 234 may include data generated as a result of the execution of one or more modules in the other modules 222.

In one implementation, the locked content module 211 provides a locked version of the digital content. The email address module 212 enables a user to feed an e-mail address to access a complete version of the digital content. The payment module 213 enables a user to feed information pertaining to initiate a payment to access the complete version of the digital content. The information comprises a name of the user, e-mail address of the user, and payment card details of the user.

The digital content module 214 grants access to the complete version of the digital content. The complete version of the digital content is displayed over a computing device 104 of the user after receiving at least one of the e-mail address and the payment from the user. The sign-up lock content module 215 adaptable to receive the e-mail address from the user and further enables a digital content provider to create at least two versions of the digital content in a graphics program. The first version provides the digital content in a lock mode, and the second version provides the digital content in an unlocked mode. In an embodiment, a sign-up description provides detail about the offers, discounts, and advertisements.

The sign-up lock editor module 216 enables the digital content provider to integrate an unlock button to the first version of the digital content. The unlock button linked to a sign-up form and redirects to display the complete version of the digital content on receiving the e-mail address of the user in the sign-up form. The sign-up lock user experience module 217 provides a user with a promotional link on a social media platform. The user clicks on the promotional link to see the digital content. However, the user can only see the partially locked digital content so that they can have a look before sign-up. Then the user clicks on an unlock button which leads the user to a sign-up form. The sign-up form enables the user to submit his/her e-mail id. After that, the present system displays the second full version of the digital content, and also the user receives an e-mail with a link to the full version of digital content to keep as a reference.

The payment lock content module 218 adaptable to receive the payment from the user enables the digital content provider to create at least two versions of the digital content in a graphics program. The first version provides the digital content in a lock mode, and the second version provides the digital content in an unlocked mode. The payment lock editor module 219 enables the digital content provider to integrate a link to a hotspot in the first version of the digital content. The hotspot links to a payment form which displays the product and price details related to the Product ID. The payment lock editor module 219 enables the digital content provider to select a pay lock option. Further, the digital content provider integrates a product ID from a payment gateway. The product ID relates to a predefined price of the corresponding digital content.

The payment lock user experience module 220 provides a user with a promotional link on a social media platform. The user clicks on the promotional link to see the digital content. However, the user can only see the partially locked digital content so that they can have a look before the payment. Then the user clicks on a payment button which leads the user to a payment form. The payment form enables the user to submit his/her name, e-mail id, credit card/debit card information to accomplish the payment process. After that, the present system displays the second full version of the digital content and also the user receives an e-mail with a link to the full version of digital content to keep as a reference.

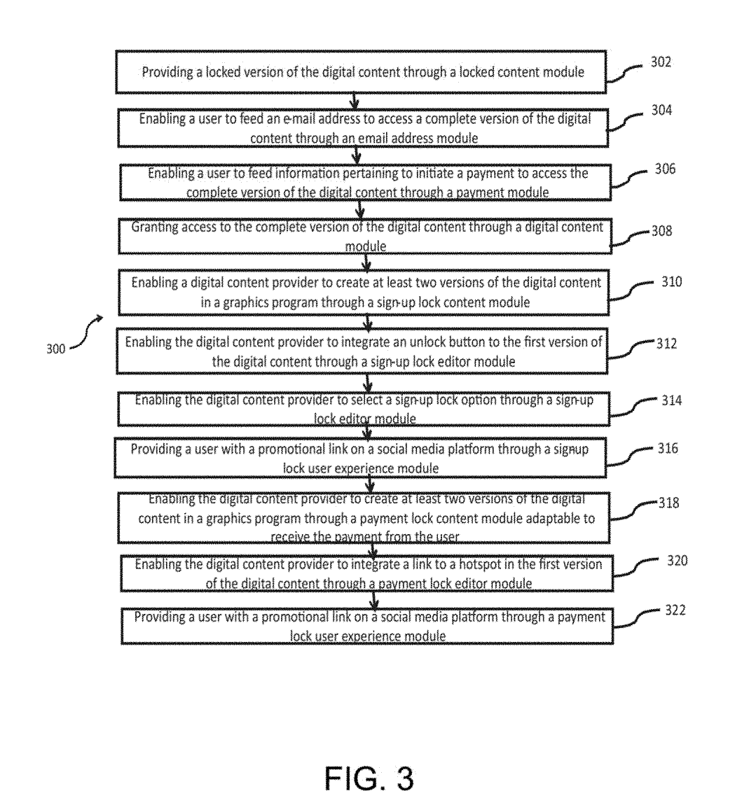

FIG. 3 illustrates a flowchart 300 of the method for locking digital content and granting access to the locked digital content, in accordance with at least one embodiment. The method initiates with the step 302 of providing a locked version of the digital content through a locked content module. Then the method includes a step 304 of enabling a user to feed an e-mail address to access a complete version of the digital content through an email address module. The method further includes a step 306 of enabling a user to feed information pertaining to initiate a payment to access the complete version of the digital content through a payment module. The information comprises a name of the user, e-mail address of the user, and payment card details of the user.

The method includes a step 308 of granting access to the complete version of the digital content through a digital content module. The complete version of the digital content is displayed over a computing device of the user after receiving at least one of the e-mail address and the payment from the user.

Further, the method includes the step 310 of enabling a digital content provider to create at least two versions of the digital content in a graphics program through a sign-up lock content module adaptable to receive the e-mail address from the user. The first version provides the digital content in a lock mode, and the second version provides the digital content in an unlocked mode.

The method then includes the step 312 of enabling the digital content provider to integrate an unlock button to the first version of the digital content through a sign-up lock editor module. The unlock button linked to a sign-up form and redirects to display the complete version of the digital content on receiving the e-mail address of the user in the sign-up form. The sign-up lock editor module comprises step 314 of enabling the digital content provider to select a sign-up lock option. The digital content provider further selects a desired location to save the received e-mail addresses of the users.

Furthermore, the method includes the step 316 of providing a user with a promotional link on a social media platform through a sign-up lock user experience module. The method then includes the step 318 of enabling the digital content provider to create at least two versions of the digital content in a graphics program through a payment lock content module adaptable to receive the payment from the user. The first version provides the digital content in a lock mode, and the second version provides the digital content in an unlocked mode.

Then the method includes the step 320 of enabling the digital content provider to integrate a link to a hotspot in the first version of the digital content through a payment lock editor module. The payment lock editor module enables the digital content provider to select a pay lock option. Further, the digital content provider integrates a product ID from a payment gateway. The product ID relates to a predefined price of the corresponding digital content. Then the method includes a step 322 of providing a user with a promotional link on a social media platform through a payment lock user experience module.

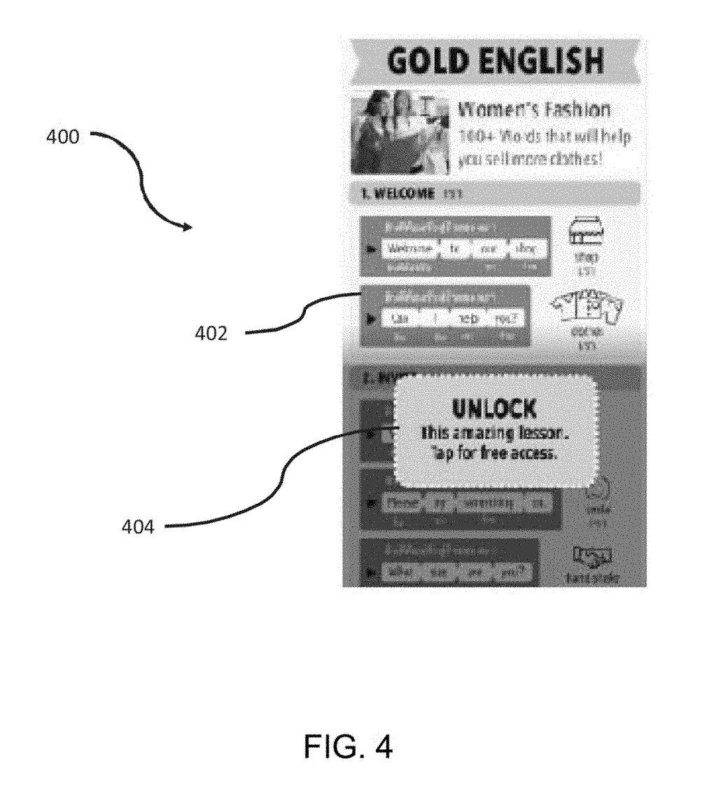

FIG. 4 illustrates a first exemplary view 400 of the locked content module, in accordance with at least one embodiment FIG. 4 is explained in conjunction with FIG. 2. The locked content module provides a locked version of the digital content 402 which displays an unlock button 404 to access the full version of the digital content. The digital content provider sets an option to let the user play the rest of the digital content on receiving the email of the user.

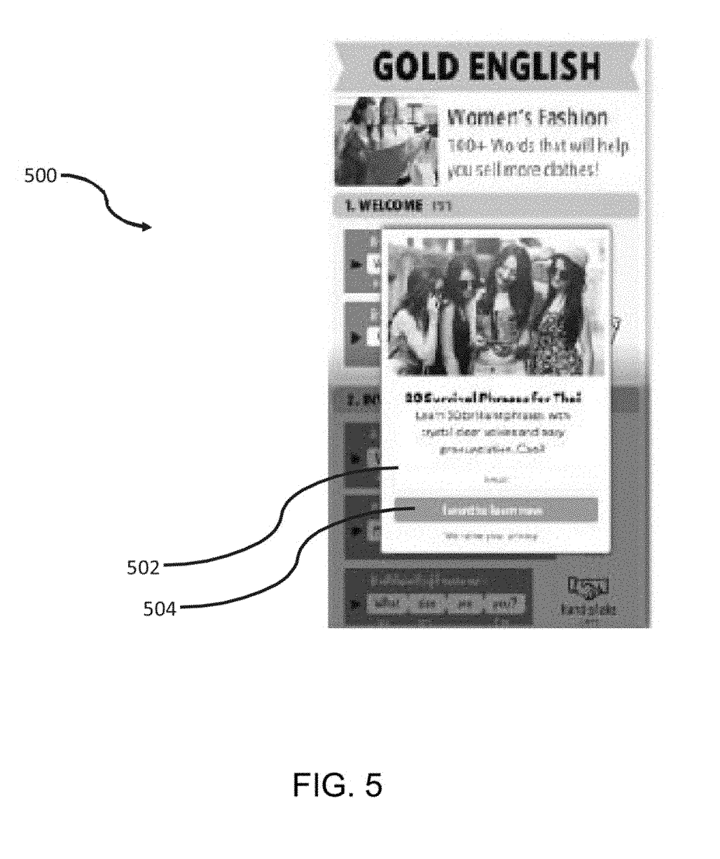

FIG. 5 illustrates an exemplary view 500 of an e-mail address module, in accordance with at least one embodiment. FIG. 5 is explained in conjunction with FIG. 2. The e-mail address module enables the user to feed 502 his/her e-mail address to access 504 the complete version of the digital content. After receiving the email of the user or payment, the full version of the digital content is displayed on the computing device of the user. In an embodiment, the e-mail address may be utilized for future marketing.

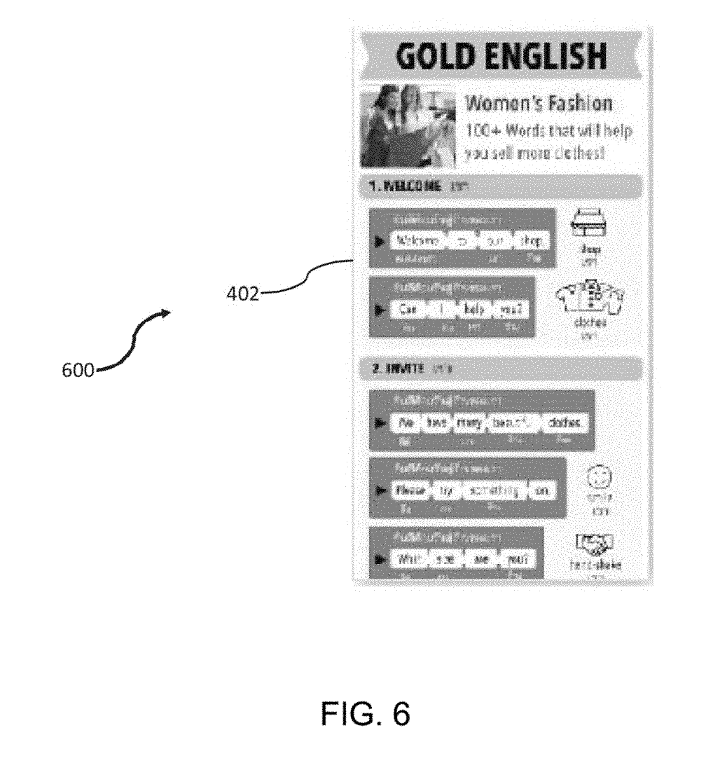

FIG. 6 illustrates the first exemplary view 600 of the digital content module, in accordance with at least one embodiment. The digital content module provides the user with the access to the full version of the digital content 402 on receiving the e-mail address of the user.

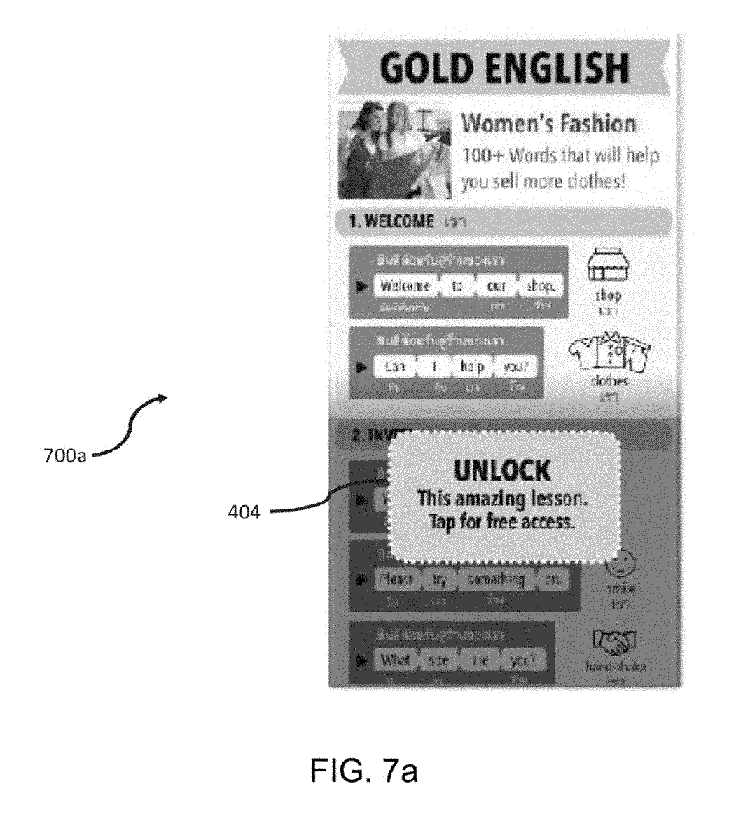

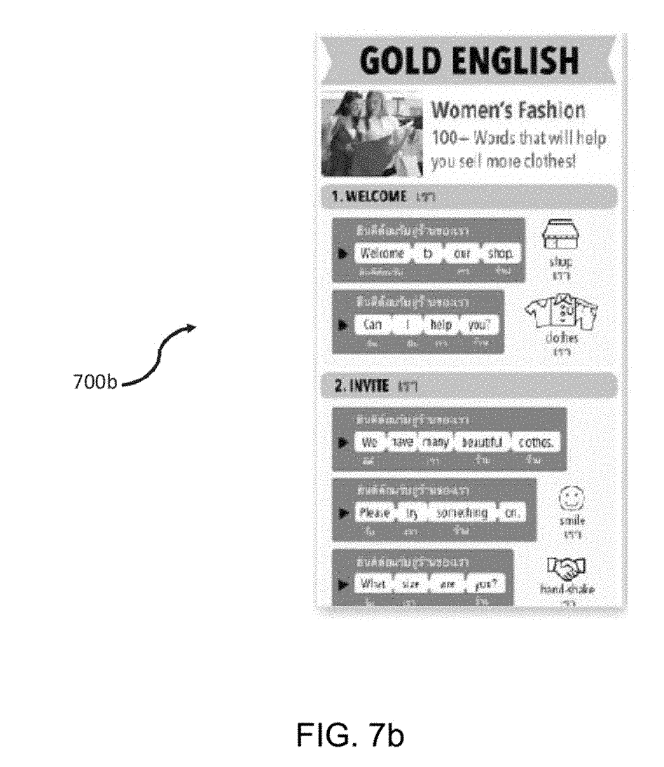

FIGS. 7a-7b illustrate an exemplary view of the sign-up lock content module, in accordance with at least one embodiment. The sign-up lock content module enables the digital content provider to create two versions 700a and 700b of the digital content in a graphics program. In a first version 700a, the digital content is in lock mode, and in the second version, the digital content is in unlocked mode. The first version has an unlock button 404 as an indication to submit the email id.

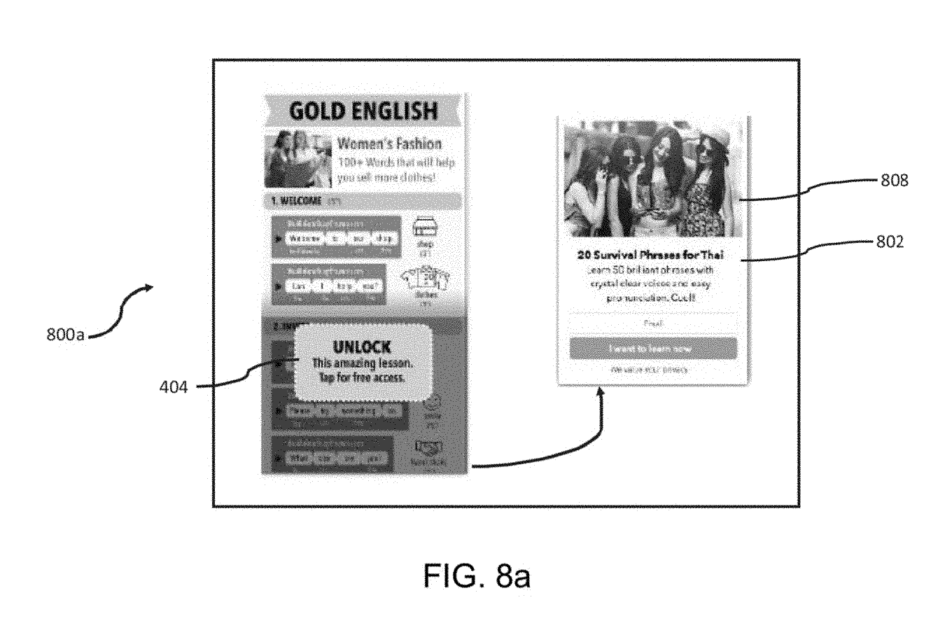

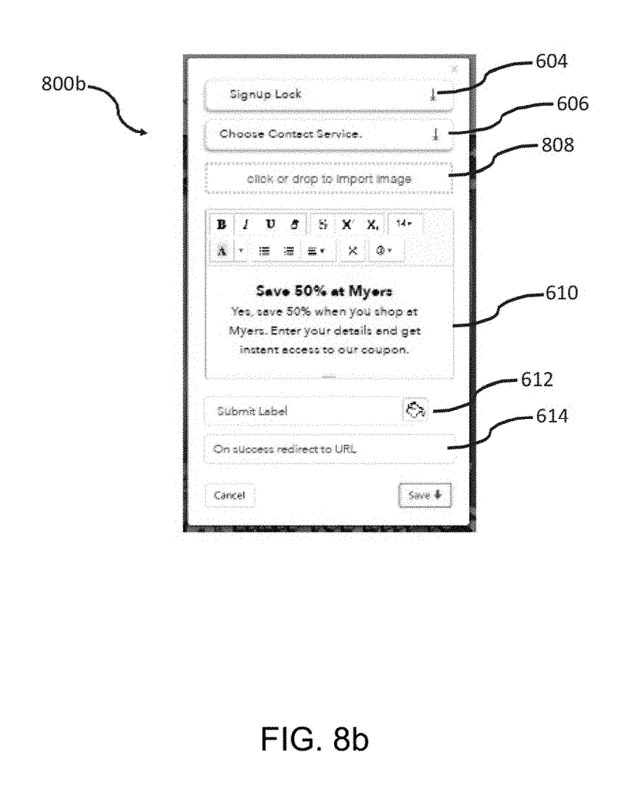

FIGS. 8a-8b illustrate an exemplary view 800a and 800b of the sign-up lock editor module, in accordance with at least one embodiment. The sign-up lock editor module enables the digital content provider to add an unlock button 404 to the first version of the digital content that is locked. The unlock button 404 links to a sign-up form 802. After submitting the e-mail address, the sign-up form 802 redirects to display a full version of the digital content.

The sign-up lock editor module further enables the digital content provider to select the sign-up lock option 604, and the digital content provider can also select the desired location 606 to save the submitted mails of the users. Further, the sign-up lock editor module enables the digital content provider to configure a signup image 808, a signup description 610, and a submit label 612. Additionally, the digital content provider adds a web address URL 614 which enables the user to access the complete digital content on submitting the e-mail address. The sign-up description 610 provides detail about the offers, discounts, and advertisements.

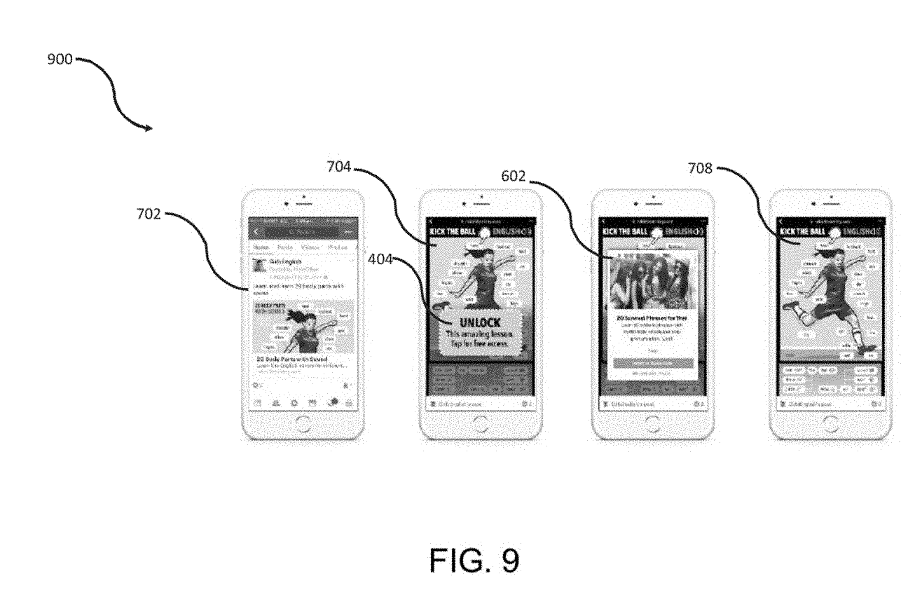

FIG. 9 illustrates an exemplary view 900 of the sign-up lock user experience module 216, in accordance with at least one embodiment. The sign-up lock user experience module 216 provides a user with a promotional link 702 on a social media platform such as Facebook, or on a web page. The user clicks on the promotional link 702 to see the digital content. However, the user can only see the partially locked digital content 704 so that they can have a look before sign-up.

Then the user clicks on an unlock button 404 which leads the user to a sign-up form 602. The sign-up form 602 enables the user to submit his/her e-mail id. Thereafter, the present system displays 708 the second full version of the digital content, and also the user receives an e-mail with a link to the full version of digital content to keep as a reference.

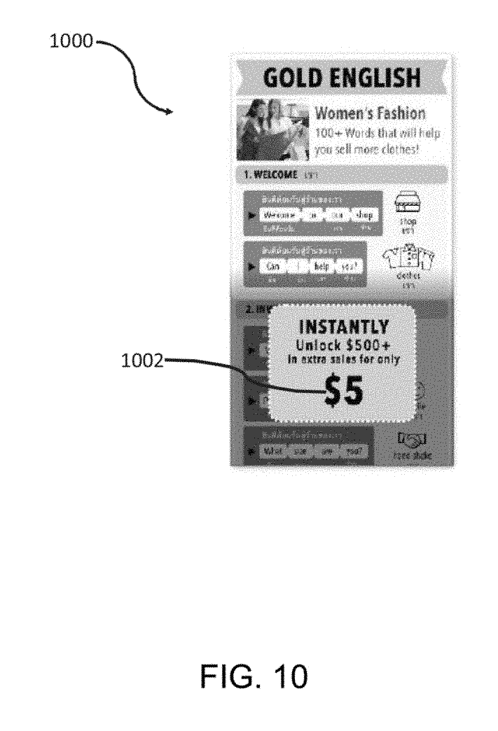

FIG. 10 illustrates a second exemplary view 1000 of the locked content module, in accordance with at least one embodiment. The locked content module provides a locked version of the digital content. The locked version of the digital content such as tutorials, informative videos or templates can be accessed only after receiving a predefined payment amount 1002.

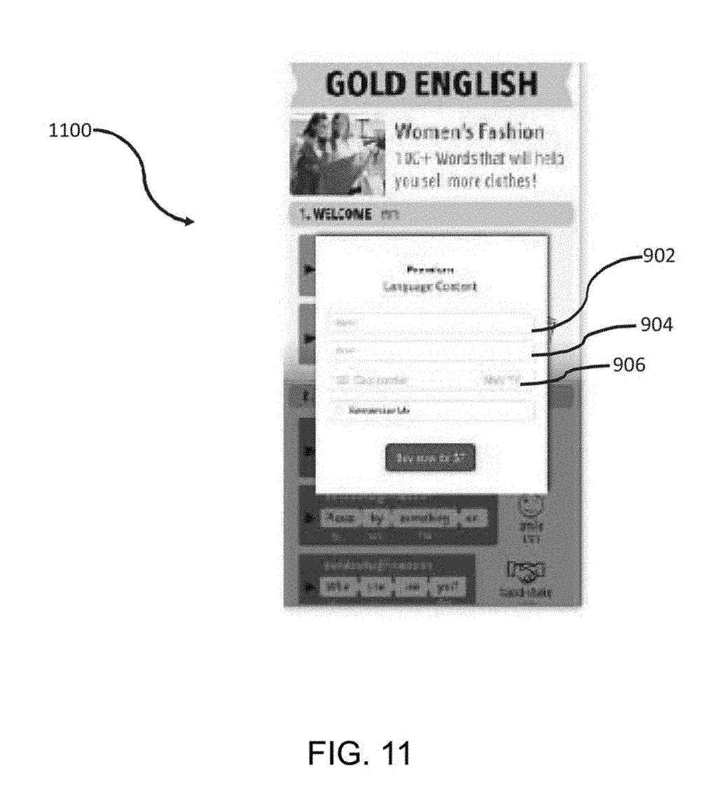

FIG. 11 illustrates an exemplary view 900 of a payment module, in accordance with at least one embodiment. The payment module enables a user to feed the payment information such as name 902, e-mail address 904, and credit card/debit card details 906 to access the complete version of the digital content. After receiving the payment from the user, the full version of the digital content is displayed on the computing device of the user.

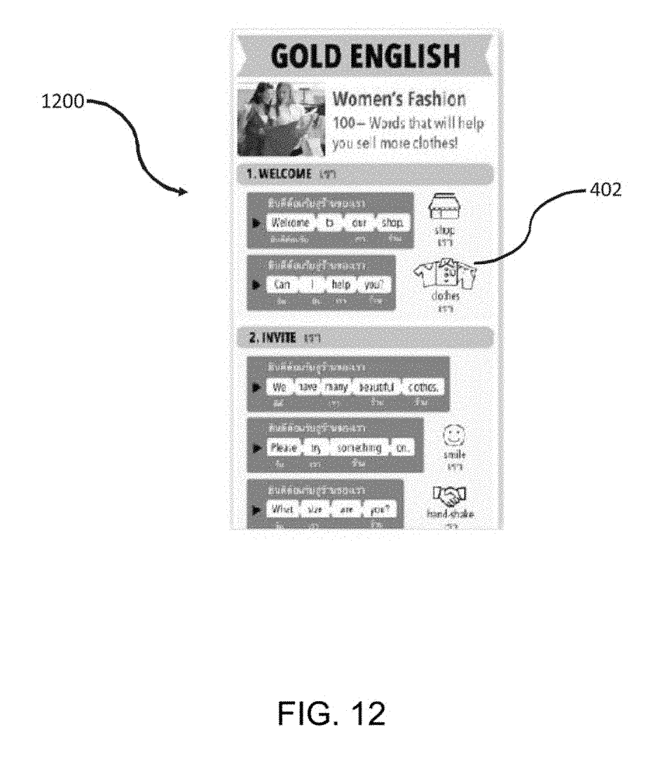

FIG. 12 illustrates a second exemplary view 1000 of the digital content module, in accordance with at least one embodiment. The digital content module provides the user with the access to the full version of the digital content 402 on receiving the payment from the user.

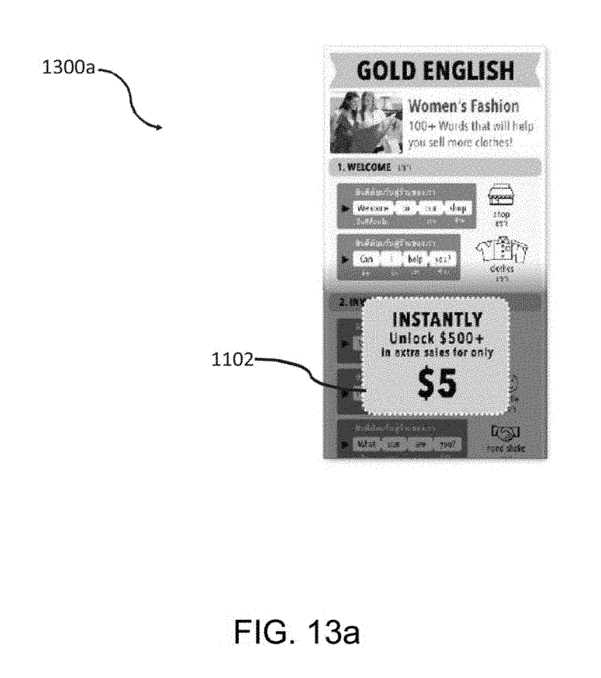

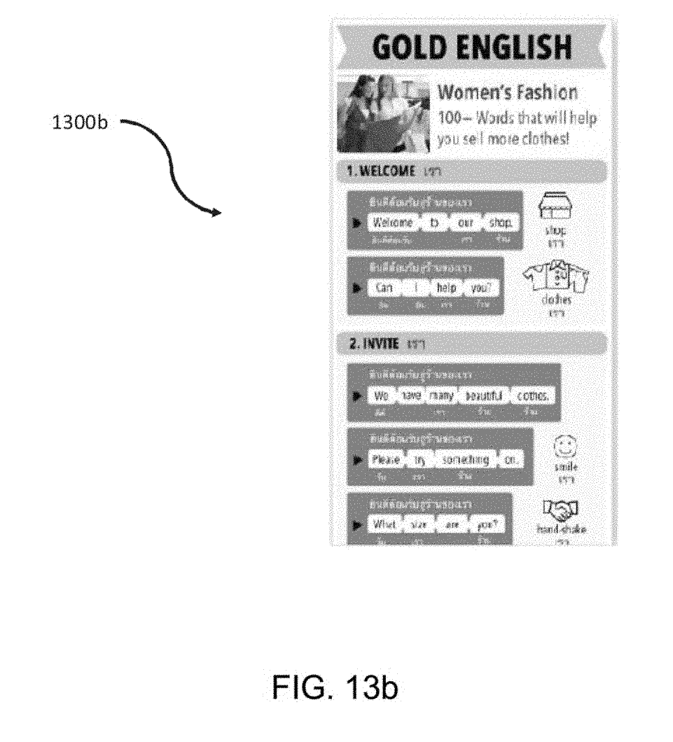

FIGS. 13a-13b illustrate an exemplary view 1300a and 1300b of the payment lock content module, in accordance with at least one embodiment. The payment lock content module enables the digital content provider to create two versions of the digital content in a graphics program. In a first version 1300a, the digital content is in lock mode, and in the second version 1300b, the digital content is in unlocked mode. The first version has a payment button 1102 as an indication to pay the displayed amount.

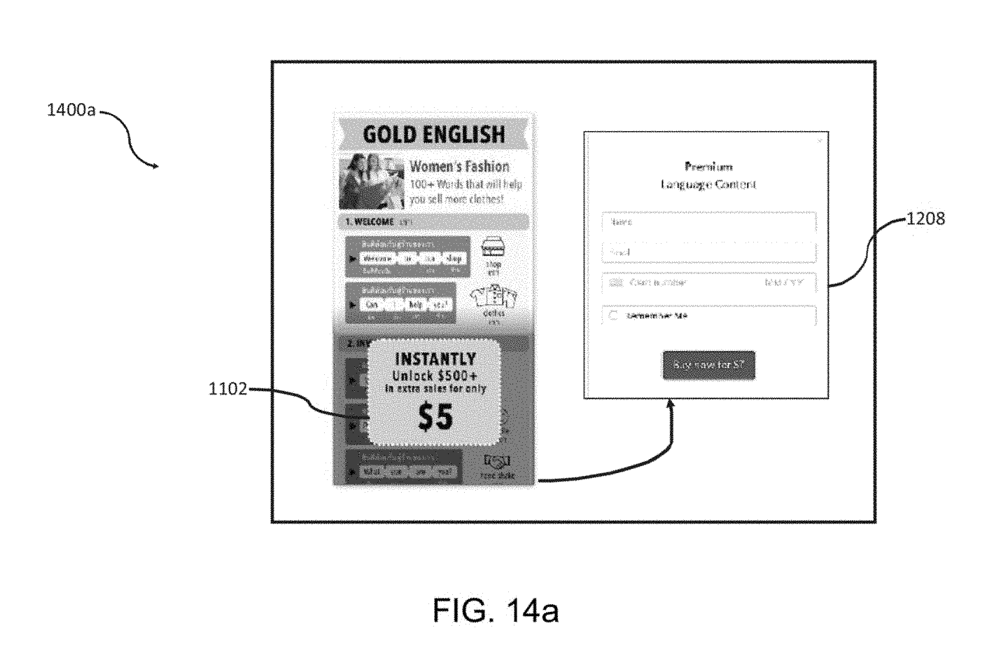

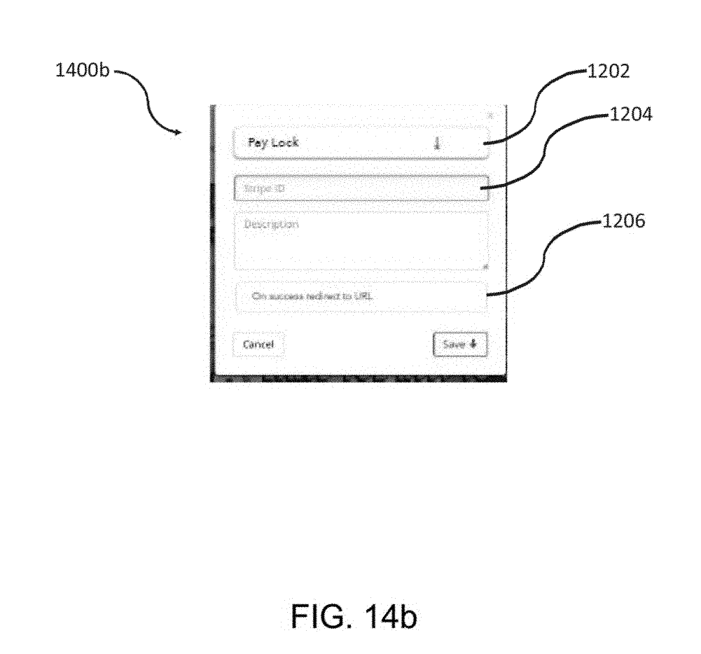

FIGS. 14a-14b illustrate an exemplary view 1400a and 1400b of the payment lock editor module, in accordance with at least one embodiment. The payment lock editor module enables the digital content provider to add a link to a hotspot (payment button 1102) in the first version of the digital content that is locked. The payment lock editor module enables the digital content provider to select the pay lock option 1202, and the digital content provider also adds a product ID 1204 from a payment gateway that relates to the price for the corresponding digital content. Further, the payment lock editor module enables the digital content provider to add a web address URL 1206 which redirects the user to access the complete digital content on receiving the payment. The hotspot links to a payment form 1208 which displays the product and price details related to the Product ID 1204.

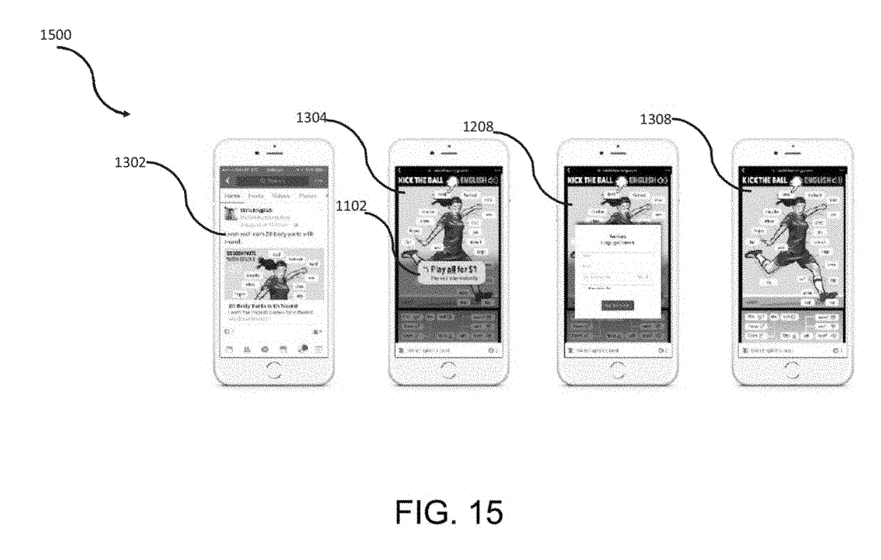

FIG. 15 illustrates an exemplary view 1500 of the payment lock user experience module, in accordance with at least one embodiment. The payment lock user experience module provides a user with a promotional link 1302 on a social media platform such as Facebook, or on a web page. The user clicks on the promotional link 1302 to see the digital content. However, the user can only see the partially locked digital content so that they can have a look before the payment. Then the user clicks on a payment button 1102 which leads the user to a payment form 1208.

The payment form 1208 enables the user to submit his/her name, e-mail id, credit card/debit card information in order to accomplish the payment process. After that, the present system displays the second full version 1308 of the digital content and also the user receives an e-mail with a link to the full version of digital content to keep as a reference.

The present system can be utilized as a software application or web application. The present system is integrated with a social media platform and does not require a prior installation on a computing device. The present system provides a hyperlink to an individual piece of the limited digital content that can be turned into a full version of the lesson, with an e-mail address or payment. Therefore the present system does not require the installation of any plugins related to the social media platforms. The hyperlinks to the protected content can function any computing devices such as desktops or mobile devices.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

1. A computer-implemented method for locking digital content and granting access to the locked digital content, the method comprises steps of:
providing, by one or more processors, a locked version of the digital content through a locked content module;
enabling, by one or more processors, a user to feed an e-mail address to access a complete version of the digital content through an email address module;
enabling, by one or more processors, a user to feed information pertaining to initiate a payment to access the complete version of the digital content through a payment module, wherein the information comprises a name of the user, e-mail address of the user, and payment card details of the user;
granting, by one or more processors, access to the complete version of the digital content through a digital content module, wherein the complete version of the digital content is displayed over a computing device of the user after receiving at least one of the e-mail address and the payment from the user;
enabling, by one or more processors, a digital content provider to create at least two versions of the digital content in a graphics program through a sign-up lock content module adaptable to receive the e-mail address from the user, wherein the first version provides the digital content in a lock mode, and the second version provides the digital content in an unlocked mode;
enabling, by one or more processors, the digital content provider to integrate an unlock button to the first version of the digital content through a sign-up lock editor module, wherein the unlock button linked to a sign-up form and redirects to display the complete version of the digital content on receiving the e-mail address of the user in the sign-up form;
providing, by one or more processors, a user with a promotional link on a social media platform through a sign-up lock user experience module;
enabling, by one or more processors, the digital content provider to create at least two versions of the digital content in a graphics program through a payment lock content module adaptable to receive the payment from the user, wherein the first version provides the digital content in a lock mode, and the second version provides the digital content in an unlocked mode;
enabling, by one or more processors, the digital content provider to integrate a link to a hotspot in the first version of the digital content through a payment lock editor module, wherein the payment lock editor module enables the digital content provider to select a pay lock option, further the digital content provider integrates a product ID from a payment gateway, wherein the product ID relates to a predefined price of the corresponding digital content; and
providing, by one or more processors, a user with a promotional link on a social media platform through a payment lock user experience module.

2. The method according to claim 1, wherein the sign-up lock editor module enables the digital content provider to select a sign-up lock option, wherein the digital content provider further selects a desired location to save the received e-mail addresses of the users.

3. The method according to claim 1, wherein the locked version of the digital content comprises a plurality of tutorials, a plurality of multimedia files, and a plurality of templates.

4. The method according to claim 1, wherein the sign-up lock editor module enables the digital content provider to configure a signup image, a signup description, and a submit label.

5. The method according to claim 1, wherein the sign-up lock editor module enables the digital content provider to integrate a first web address URL to enable the user to access the complete digital content on submitting the e-mail address.

6. The method according to claim 1, wherein the payment lock editor module enables the digital content provider to integrate a second web address URL which redirects the user to access the complete digital content on receiving the payment.

7. A system to lock digital content and grant access to the locked digital content, the system comprises:
a processor; and
a memory to store machine-readable instructions that when executed by the processor cause the processor to:
provide a locked version of the digital content through a locked content module;
enable a user to feed an e-mail address to access a complete version of the digital content through an email address module;
enable a user to feed information pertaining to initiate a payment to access the complete version of the digital content through a payment module, wherein the information comprises a name of the user, e-mail address of the user, and payment card details of the user;
grant access to the complete version of the digital content through a digital content module, wherein the complete version of the digital content is displayed over a computing device of the user after receiving at least one of the e-mail address and the payment from the user;
enable a digital content provider to create at least two versions of the digital content in a graphics program through a sign-up lock content module adaptable to receive the e-mail address from the user, wherein the first version provides the digital content in a lock mode, and the second version provides the digital content in an unlocked mode;
enable the digital content provider to integrate an unlock button to the first version of the digital content through a sign-up lock editor module, wherein the unlock button linked to a sign-up form and redirects to display the complete version of the digital content on receiving the e-mail address of the user in the sign-up form;
provide a user with a promotional link on a social media platform through a sign-up lock user experience module;
enable the digital content provider to create at least two versions of the digital content in a graphics program through a payment lock content module adaptable to receive the payment from the user, wherein the first version provides the digital content in a lock mode, and the second version provides the digital content in an unlocked mode;
enable the digital content provider to integrate a link to a hotspot in the first version of the digital content through a payment lock editor module, wherein the payment lock editor module enables the digital content provider to select a pay lock option, further the digital content provider integrates a product ID from a payment gateway, wherein the product ID relates to a predefined price of the corresponding digital content; and
provide a user with a promotional link on a social media platform through a payment lock user experience module.

8. The system according to claim 7, wherein the sign-up lock editor module enables the digital content provider to select a sign-up lock option, wherein the digital content provider further selects a desired location to save the received e-mail addresses of the users.

9. The system according to claim 7, wherein the locked version of the digital content comprises a plurality of tutorials, a plurality of multimedia files, and a plurality of templates.

10. The system according to claim 7, wherein the sign-up lock editor module enables the digital content provider to configure a signup image, a signup description, and a submit label.

11. The system according to claim 7, wherein the sign-up lock editor module enables the digital content provider to integrate a first web address URL to enable the user to access the complete digital content on submitting the e-mail address.

12. The system according to claim 7, wherein the payment lock editor module enables the digital content provider to integrate a second web address URL which redirects the user to access the complete digital content on receiving the payment.
